(19) United States
(12) Patent Application Publication
(10) Pub. No.: US 2017/0286074 A1
(43) Pub. Date: Oct. 5, 2017

(54) Electronic Device and Method for Multiple Compiling Platforms

(71) Applicants: Le Holdings (Beijing) Co., Ltd., Beijing (CN); LE SHI ZHI XIN ELETRONIC TECHNOLOGY (TIANJIN) LIMITED, Tianjin (CN)

(72) Inventor: Tao Lei, Tianjin (CN)

(21) Appl. No.: 15/242,534

(22) Filed: Aug. 21, 2016

Related U.S. Application Data
(63) Continuation of application No. PCT/CN2016/089545, filed on Jul. 10, 2016.

(30) Foreign Application Priority Data
Mar. 29, 2016 (CN) 2016101873964

(51) Int. Cl. G06F 9/45

(52) U.S. Cl. CPC G06F 8/41

(57) ABSTRACT

Embodiments of the present disclosure relate to the field of compiling technologies for multiple compiling platforms and disclose a compiling method and electronic device for multiple compiling platforms. The method includes: detecting a compiling environment needed by a compiled object; performing mapping by a mapping table according to the compiling environment to obtain a corresponding compilation path; and obtaining a corresponding configuration element according to the compilation path, and executing compiling by using the configuration element. In the embodiments of the present disclosure, configuration elements of multiple compiling platforms are integrated together, and a compilation path of each compiling platform is obtained by a mapping table, allowing one handheld device to compile applications produced by multiple vendors.

### CROSS-REFERENCE TO RELATED APPLICATIONS

The present application is a continuation of PCT application No. PCT/CN2016/089545 submitted on Jul. 10, 2016, and claims priority to Chinese Patent Application No. 201610187396.4, filed on Mar. 29, 2016 and entitled “COMPILING SYSTEM AND METHOD FOR MULTIPLE COMPILING PLATFORMS,” which is incorporated herein by reference in its entirety.

### TECHNICAL FIELD

The present disclosure relates to compiling technologies for multiple compiling platforms, and specifically, to a compiling method and electronic device for multiple compiling platforms.

### BACKGROUND

At present, an intelligent handheld device has an independent operating system and an independent operating space as a computer does, and may be installed spontaneously by a user with applications such as software, games, and navigation, etc., and may also implement a wireless network access by means of a mobile communication network.

In a process of implementing the present disclosure, the inventor found that in a process of installing a new application, a server needs to compile the application. Compiling is a process in which a source program encoded in a source language generates a target program, and is an action of generating a target program with a compiling program. Compiling is to convert a high-level language to a binary language recognizable by a computer, and a compiling program converts a language familiar to people to a machine-recognizable language. An operating process in which a source program is translated into a target program by a compiling program is divided into five phases: a lexical analysis, a grammar analysis, a semantic check and intermediate code generation, code optimization, and target code generation. The lexical analysis and the grammar analysis are mainly performed, which are alternatively referred to as a source program analysis. If a grammatical error is found in the analysis process, prompt information is provided. If a compilation process cannot be completed in a process of installing a new application, the installation of the new application fails.

In prior art, each vendor has its own compiling platform, but a compiling platform of each vendor is mutually independent, and the compiling platform of each vendor can only compile an application produced by itself, that is, a compiling platform of vendor A cannot be used to compile an application produced by vendor B. However, one handheld device can be installed with only one chip for compiling, that is, one handheld device can have only one compiling platform. It is infeasible for a user who expects to use his own handheld device (for example, produced by the vendor A), to download an application produced by other vendors (for example, produced by the vendor B), which brings great inconvenience to the user.

### SUMMARY

An objective of the embodiments of the present disclosure is to provide a compiling method and electronic device for multiple compiling platforms, which are used to resolve a problem of compiling an application that needs different compiling platforms.

On a first aspect, an embodiment of the present disclosure provides a compiling method for multiple compiling platforms, where the method includes: detecting a compiling environment needed by a compiled object; performing mapping by using a mapping table according to the compiling environment to obtain a corresponding compilation path; and obtaining a corresponding configuration element according to the compilation path, and executing compiling by using the configuration element.

On a second aspect, an embodiment of the disclosure further provides a non-volatile computer storage medium, which stores computer executable instructions, where the computer executable instructions are used to execute any of the foregoing compiling method for multiple compiling platforms of the application.

On a third aspect, an embodiment of the disclosure further provides an electronic device, including: at least one processor; and a memory, where the memory stores a program that can be executed by the at least one processor, and the instructions are executed by the at least one processor, so that the at least one processor can execute any of the foregoing compiling method for multiple compiling platforms of the disclosure.

According to the compiling method and electronic device for multiple compiling platforms provided by the embodiments of the present disclosure, configuration elements of multiple compiling platforms are integrated together, and a compilation path of each compiling platform is obtained by a mapping table, so that one handheld device can compile an application produced by multiple vendors.

Other characteristics and advantages of the present disclosure are described in detail in the following part of Detailed Description.

### BRIEF DESCRIPTION OF THE DRAWINGS

One or more embodiments are exemplarily described by figures corresponding thereto in the accompanying drawings, and the exemplary descriptions do not constitute a limitation on the embodiments. Elements with the same reference numbers in the accompanying drawings represent similar elements. Unless otherwise particularly stated, the figures in the accompanying drawings do not constitute a scale limitation.

FIG. 1 is a block diagram of a compiling system for multiple compiling platforms according to certain embodiments of the present disclosure;

FIG. 2 is a schematic diagram of message-delivery of a compilation process according to certain embodiments of the present disclosure; and

FIG. 3 is a flowchart of a compiling method for multiple compiling platforms according to certain embodiments of the present disclosure;

FIG. 4 is a schematic structural diagram of hardware of a device for executing a compiling method for multiple compiling platforms according to certain embodiments of the present disclosure.

### DETAILED DESCRIPTION

Specific implementation manners of some embodiments of the present disclosure are described in detail with reference to accompanying drawings in the following. It should be understood that the specific implementation manners described herein are only for the purpose of specifying and explaining the present disclosure and not intended to limit the present disclosure.

Some embodiments of the present disclosure use a handheld device as an example for description. However, the present disclosure may be applicable to not only a user handheld device, but also to an intelligent hardware product such as a television, a box, a router, an Internet of Vehicles system, virtual reality and the like. Applications of the technical solutions provided by the present disclosure to intelligent hardware products such as a television, a box, a router, an Internet of Vehicles system, virtual reality and the like shall also fall within the protection scope of the present disclosure.

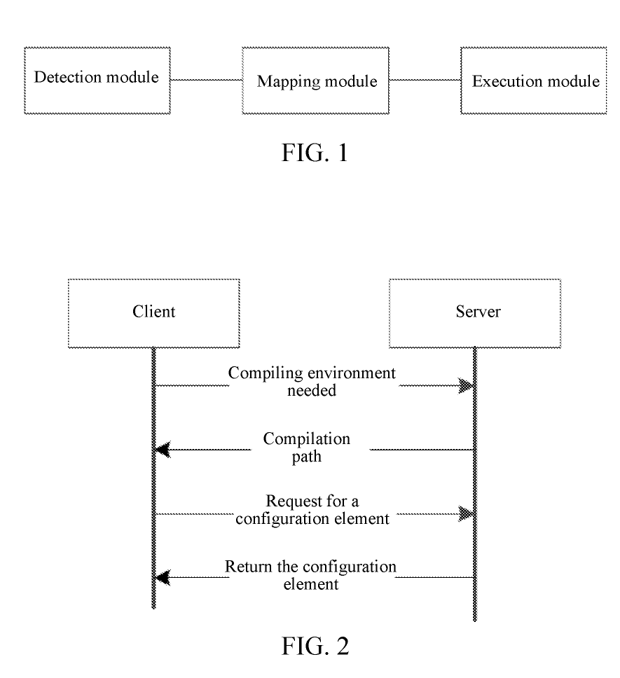

FIG. 1 is a block diagram of a compiling system for multiple compiling platforms according to an embodiment of the present disclosure. As shown in FIG. 1, the system includes a detection module, a mapping module and an execution module. The detection module is configured to detect a compiling environment needed by a compiled object. The mapping module is configured to perform mapping by a mapping table according to the compiling environment to obtain a corresponding compilation path. The execution module is configured to obtain a corresponding configuration element according to the compilation path, and to execute compiling by using the configuration element.

The compiled object refers to a new application to be installed on the handheld device. Persons skilled in the art should understand that in a process in which an application is installed, the application needs to be compiled. The compiled application is referred to as a compiled object here.

Generally, when installing multiple applications, a user will install the applications one by one, that is, one handheld device will compile only one compiled object at the same time, and the detection module will detect a compiling environment needed by the compiled object being compiled.

However, if a user installs multiple applications at the same time, that also is, one handheld device compiles multiple compiled objects at the same time, the detection device detects compiling environments needed by the multiple compiled objects at the same time, and performs mapping for each of the compiling environments to obtain compilation paths (at this time, multiple compilation paths are obtained) corresponding to each of the compiling environments; and then the execution module respectively obtains, according to the obtained multiple compilation paths, corresponding configuration elements, that is, configuration elements corresponding to each of the compiled objects, and there are multiple configuration elements at this time, and executes compiling the compiled objects corresponding to each of the configuration elements by using the obtained multiple configuration elements.

The compiling environment refers to an operating environment needed to compile an application, for example, an operating system, Office and other software. The mapping table includes compilation paths respectively corresponding to each of the multiple compiling environments, and mapping relationships between each compiling environment and a corresponding compilation path. The compilation path here is a path by which the configuration element may be found. One compiling environment is mapped to one compilation path and the mapping table stores such a mapping relationship, and stores specific content of each compilation path (here briefly referred to as compilation path).

The compiling system for multiple compiling platforms provided by an embodiment of the present disclosure further includes a storage module. The storage module is configured to store a configuration element of each of the multiple compiling environments, where the respective configuration element of each of the compiling environments is respectively stored in different folders, so that each of the compiling environments has different compilation paths, respectively. The configuration element includes a configuration file and a compiling tool, and each of the multiple compiling platforms corresponds to one compiling environment.

Persons skilled in the art should understand that there may be one or more configuration elements corresponding to each compiling environment. If one compiling environment corresponds to one configuration element, the mapping module obtains one compilation path by the mapping table according to the compiling environment, and the execution module obtains a corresponding configuration element by the compilation path, and executes a compiling process by using the configuration element. If one compiling environment corresponds to multiple configuration elements, the mapping module obtains multiple compilation paths by the mapping table according to the compiling environment, and the execution module respectively obtains corresponding multiple configuration elements by the multiple compilation paths, and executes a compiling process by using the multiple configuration elements.

There may be one or more configuration files and compiling tools included in the configuration element, that is, one configuration element may include one configuration file and one compiling tool, or may include one configuration file and multiple compiling tools, or may include multiple configuration files and one compiling tool, or may include further multiple configuration files and multiple compiling tools.

Persons skilled in the art should understand that whether the number of the configuration file and the compiling tool included in the configuration element is one or more is determined by a requirement of the compiled object to be compiled. Which configuration element is needed by a compiled object is not an invention concept of the present disclosure and belongs to content of prior art, and details are not described herein.

FIG. 2 is a schematic diagram of message-delivery of a compilation process according to an embodiment of the present disclosure. The above-described operations performed by the detection module and the execution module are completed at a client side, operations performed by the mapping module are completed at a server side, and the storage module is disposed at the server side.

Referring to FIG. 2, when a compiled object needs to be compiled, a client detects a compiling environment needed by the compiled object, and sends information of the detected and needed compiling environment as a message to the client. After receiving the message including the needed compiling environment, the client finds a compilation path corresponding to the compiling environment by a mapping table, that is, the client finds, by searching the table, the path by which a corresponding configuration element can be obtained, i.e., a compilation path, and sends the compilation path as a message to the client. After receiving the message including the compilation path, the client requests the client for a configuration element according to the received compilation path. After receiving the request, the server finds a corresponding configuration element in the storage module, and sends the configuration element to the client, and the client executes a compiling process by using the received configuration element.

For a client, the executed operations include: detecting a compiling environment needed by a compiled object; sending a message including the needed compiling environment to a server; after receiving a message including a compilation path (the number of which may be one or more) sent by the server, sending again a request for a configuration element to the server; and executing a compiling process in a case of receiving the configuration element returned by the server.

For a server, the executed operations include: after receiving the message including the compiling environment, performing mapping by a mapping table to obtain a compilation path (the number of which may be one or more); afterwards sending a message including the compilation path to the client; and after receiving the request for the configuration element, sending the corresponding configuration element to the client.

In a case of compiling multiple compiled objects at the same time, there are multiple needed compiling environments, in this case, a client may include information of all the needed compiling environments in one message, and send the message to the client. Alternatively, the information may be sent separately in multiple messages, with each message including information of one compiling environment.

In a case in which there are multiple compilation paths, the multiple compilation paths may be sent by means of one message, or may be sent separately by means of multiple messages, with each message including one compilation path.

In a case in which there are multiple configuration elements, a client may send the requests for all configuration elements to a server by means of one message, and also may send the requests separately in multiple messages, with each message including the request for one configuration element.

Persons skilled in the art should understand that what is obtained here is not a compiling environment, but a specific identifier of the compiling environment. In some embodiments of the present disclosure, for the convenience of descriptions, the specific identifier of the compiling environment is briefly referred to as a compiling environment.

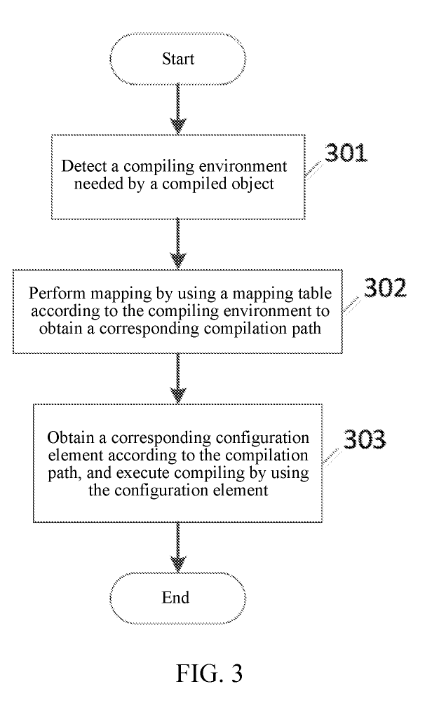

FIG. 3 is a flowchart of a compiling method for multiple compiling platforms according to an embodiment of the present disclosure. As shown in FIG. 3, the method includes:

Step 301, detecting a compiling environment needed by a compiled object.

In a case in which only one application is installed at the current time on a handheld device, only one compiled object needs to be compiled, so that only for the compiled object, the needed compiling environment (the number of which may be one or more) needs to be detected. If multiple applications are installed at the same time,

the compiling environments need to be detected respectively for multiple compiled objects, and in this way, information related to the multiple compiling environments is obtained.

Step 302: Perform mapping by a mapping table according to the compiling environment to obtain a corresponding compilation path.

In a case in which one compiling environment is detected, a compilation path (in a case in which multiple configuration elements are needed, multiple compilation paths may exist) corresponding to the compiling environment is obtained by the mapping table. In a case in which multiple compiling environments are detected, each of the compiling environments may be mapped in the mapping table to obtain at least one compilation path (the number of which may be one or more), and multiple compiling environments may be mapped in the mapping table to obtain multiple compilation paths.

Step 303: Obtain a corresponding configuration element according to the compilation path, and execute compiling by using the configuration element.

In a case in which there is only one compilation path, a corresponding configuration element is obtained by the compilation path (the number of the configuration element may be one or more, but no matter there is one configuration element or there are multiple configuration elements, the configuration elements are all stored in the compilation path. It should be easy to understand that there is only one compilation path here), and compiling is executed by using the configuration element. In a case in which there are multiple compilation paths, corresponding configuration elements, that is, multiple configuration elements, are obtained according to different compilation paths, and compiling is executed by using the obtained multiple configuration elements.

Which compiling environment is specifically used and how compiling is executed by using the configuration element are in the prior art, and are not described repeatedly.

It should be noted that specific details and advantages of the compiling method for multiple compiling platforms provided by some embodiments of the present disclosure are similar to those of the compiling system for multiple compiling platforms provided by the present disclosure, reference may be made to the descriptions above, and are not described repeatedly herein.

In an embodiment, the disclosure provides a non-volatile computer storage medium, which stores computer executable instructions, where the computer executable instructions can execute the compiling method for multiple compiling platforms of any of the foregoing method embodiments of the disclosure.

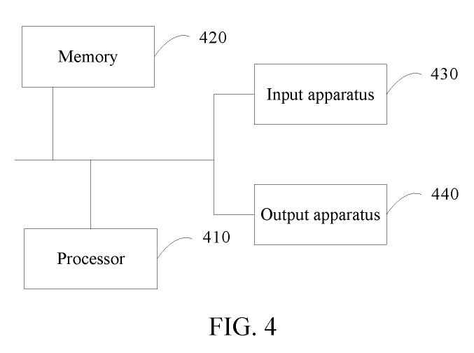

FIG. 4 is a schematic structural diagram of hardware of a device for executing a compiling method for multiple compiling platforms provided by an embodiment of the disclosure. As shown in FIG. 4, the device includes:

one or more processors 410 and a memory 420, with one processor 410 as an example in FIG. 4.

A device for executing the compiling method for multiple compiling platforms may further include: an input apparatus 430 and an output apparatus 440.

The processor 410, the memory 420, the input apparatus 430, and the output apparatus 440 can be connected by means of a bus or in other manners, with a connection by means of a bus as an example in FIG. 4.

As a non-volatile computer readable storage medium, the memory 420 can be used to store non-volatile software programs, non-volatile computer executable programs and modules, for example, program instructions/module corresponding to the compiling method for multiple compiling platforms in the embodiments of the disclosure (for example, a detection module, a mapping module and an execution module shown in FIG. 1). The processor 410 executes various functional applications and data processing of the server, that is, implements the compiling method for multiple compiling platforms of the foregoing method embodiments, by running the non-volatile software programs, instructions, and modules stored in the memory 420.

The memory 420 may include a program storage area and a data storage area, where the program storage area may store an operating system and at least one application needed by function; the data storage area may store data created according to use of a compiling system for multiple compiling platforms, and the like. In addition, the memory 420 may include a high-speed random access memory, and also may include a non-volatile memory, such as at least one disk storage device, flash storage device, or other non-volatile solid-state storage devices. In some embodiments, the memory 420 optionally includes memories remotely disposed with respect to the processor 410, and the remote memories may be connected, via a network, to the compiling system for multiple compiling platforms. Examples of the foregoing network include but are not limited to: the Internet, an intranet, a local area network, a mobile communications network, and a combination thereof.

The input apparatus 430 can receive entered digit or character information, and generate key signal inputs relevant to user setting and functional control of the compiling system for multiple compiling platforms. The output apparatus 440 may include a display device, for example, a display screen, etc.

The one or more modules are stored in the memory 420, and execute the compiling method for multiple compiling platforms in any one of the foregoing method embodiments when being executed by the one or more processors 410.

The foregoing product can execute the method provided in the embodiments of the disclosure, and has corresponding functional modules for executing the method and beneficial effects. The method provided in the embodiments of the disclosure can be referred to for technical details that are not described in detail in the embodiment.

The electronic device in the embodiment of the disclosure exists in multiple forms, including but not limited to:

(1) Mobile communication device: such devices being characterized by having a mobile communication function and a primary objective of providing voice and data communications; such type of terminals including a smart phone (for example, an iPhone), a multimedia mobile phone, a feature phone, a low-end mobile phone, and the like;

(2) Ultra mobile personal computer device: such devices belonging to a category of personal computers, having computing and processing functions, and also generally a feature of mobile Internet access; such type of terminals including PDA, MID and UMPC devices, and the like, for example, an iPad;

(3) Portable entertainment device: such devices being capable of display and play multimedia content; such type of devices including an audio and video player (for example, an iPod), a handheld game console, an e-book, an intelligent toy and a portable vehicle-mounted navigation device;

(4) Server: a device that provides a computing service; the components of the server including a processor, a hard disk, a memory, a system bus, and the like; an framework of the server being similar to that of a general-purpose computer, but higher demanding in aspects of processing capability, stability, reliability, security, extensibility, manageability or the like due to a need to provide highly reliable services; and

(5) Other electronic apparatuses having a data interaction function.

The apparatus embodiments described above are merely schematic, and the units described as separated components may or may not be physically separated; components presented as units may or may not be physical units, that is, the components may be located in one place, or may be also distributed on multiple network units. Some or all modules therein may be selected according to an actual requirement to achieve the objective of the solution of the embodiment.

Through descriptions of the foregoing implementation manners, a person skilled in the art can clearly recognize that each implementation manner can be implemented by means of software in combination with a general-purpose hardware platform, and certainly can be also implemented by hardware. Based on such an understanding, the essence or a part contributing to the relevant technologies of the foregoing technical solutions can be embodied in the form of a software product. The computer software product may be stored in a computer readable storage medium, for example, a ROM/RAM, a magnetic disk, a compact disc or the like, including several instructions for enabling a computer device (which may be a personal computer, a sever, or a network device, and the like) to execute the method described in the embodiments or in some parts of the embodiments.

Finally, it should be noted that the foregoing embodiments are only for the purpose of describing the technical solutions of the disclosure, rather than limiting thereon. Although the disclosure has been described in detail with reference to the foregoing embodiments, a person of ordinary skill in the art should understand that he/she can still modify technical solutions disclosed in the foregoing embodiments, or make equivalent replacements to some technical features therein, while such modifications or replacements do not make the essence of corresponding technical solutions depart from the spirit and scope of the technical solutions of the embodiments of the disclosure.

What is claimed is:

1. A compiling method for multiple compiling platforms applied in a terminal, comprising:
detecting a compiling environment needed by a compiled object;
performing mapping by a mapping table according to the compiling environment to obtain a corresponding compilation path; and
obtaining a corresponding configuration element according to the compilation path, and executing compiling by using the configuration element.

2. The method according to claim 1, characterized in that the mapping table comprises compilation paths respectively corresponding to each of multiple compiling environments and mapping relationships between each of the compiling environments and a corresponding compilation path.

3. The method according to claim 2, wherein the method further comprises storing a configuration element of each of the multiple compiling environments, wherein the respective configuration elements of each of the compiling environments are respectively stored in different folders, so that each of the compiling environments has different compilation paths, respectively.

4. The method according to claim 1, wherein the configuration element comprises a configuration file and a compiling tool.

5. The method according to claim 1, wherein each of the multiple compiling platforms corresponds to one compiling environment.

6. A non-volatile computer storage medium, stored with computer executable instructions that, when executed by an electronic device, cause the electronic device to:
detect a compiling environment needed by a compiled object;
perform mapping by a mapping table according to the compiling environment to obtain a corresponding compilation path; and
obtain a corresponding configuration element according to the compilation path, and execute compiling by using the configuration element.

7. An electronic device, comprising:
at least one processor; and
a memory in communication connection with the at least one processor, wherein
the memory stores instructions that can be executed by the at least one processor,
wherein execution of the instructions by the said at least one processor causes the at least one processor to:
detect a compiling environment needed by a compiled object;
perform mapping by a mapping table according to the compiling environment to obtain a corresponding compilation path; and
obtain a corresponding configuration element according to the compilation path, and execute compiling by using the configuration element.

8. The non-volatile computer storage medium according to claim 6, wherein the mapping table comprises compilation paths respectively corresponding to each of multiple compiling environments, and mapping relationships between each compiling environment and a corresponding compilation path.

9. The non-volatile computer storage medium according to claim 8, wherein the electronic device is further caused to:
store a configuration element of each of the multiple compiling environments, wherein the respective configuration elements of each of the compiling environments are respectively stored in different folders, so that each of the compiling environments has different compilation paths, respectively.

10. The non-volatile computer storage medium according to claim 6, wherein the configuration element comprises a configuration file and a compiling tool.

11. The non-volatile computer storage medium according to claim 6, wherein each of the multiple compiling platforms corresponds to one compiling environment.

12. The electronic device according to claim 7, wherein the mapping table comprises compilation paths respectively corresponding to each of multiple compiling environments, and mapping relationships between each compiling environment and a corresponding compilation path.

13. The electronic device according to claim 12, wherein at least one processor is further caused to:
store a configuration element of each of the multiple compiling environments, wherein the respective configuration elements of each of the compiling environments are respectively stored in different folders, so that each of the compiling environments has different compilation paths, respectively.

14. The electronic device according to claim 7, wherein the configuration element comprises a configuration file and a compiling tool.

15. The electronic device according to claim 7, wherein each of the multiple compiling platforms corresponds to one compiling environment.
